(19) United States
(12) Patent Application Publication
(10) Pub. No.: US 2023/0142794 A1
(43) Pub. Date: May 11, 2023

(54) IMAGE DISPLAY METHOD OF DISPLAY DEVICE

(71) Applicant: SEIKO EPSON CORPORATION, Tokyo (JP)

(72) Inventors: Katsuyoshi YAMAGUCHI, Matsumoto-shi (JP); Takeaki ARIZUMI, Sapporo-shi (JP)

(21) Appl. No.: 17/982,928

(22) Filed: Nov. 8, 2022

(30) Foreign Application Priority Data
Nov. 8, 2021 (JP) 2021-181876

(51) Int. Cl. G06F 3/14

(52) U.S. Cl. CPC G06F 3/1454; H04W 76/10

(57) ABSTRACT

An image display method of a display device includes establishing first communication between a display device and a terminal device, transmitting, to the terminal device, via the first communication, an application for transmitting image information from the terminal device to the display device and connection information used for second communication for transmitting the image information, establishing the second communication when receiving a connection request for requesting to establish the second communication, the connection request being transmitted by the application operating in the terminal device, receiving the image information from the terminal device via the second communication, and displaying an image based on the image information.

The present application is based on, and claims priority from JP Application Serial Number 2021-181876, filed Nov. 8, 2021, the disclosure of which is hereby incorporated by reference herein in its entirety.

### BACKGROUND

### 1. Technical Field

The present disclosure relates to an image display method of a display device.

### 2. Related Art

There has been known, for example, a conference system in which conference equipment such as a printer and a projector, a mediating machine set in a conference room, and information processing terminals used by participants in a conference are connected. For example, a conference system described in JP-A-2017-33396 (Patent Literature 1) includes an application server that stores a conference system application. The conference system application is an application used to use conference equipment and download materials distributed in a conference. In the conference system, when an information processing terminal and a mediating machine are connected, the mediating machine notifies access information for accessing the application server. The information processing terminal downloads a conference system application from the application server.

In the technique described in Patent Literature 1, when image projection is performed using a projector, after installing the conference system application in the information processing terminal, a user needs to designate the projector, which is a connection destination, in the conference system application. It takes time for the user to designate the projector. The user cannot immediately project an image using the projector. For example, after retrieving a connectable projector using the conference system application, checking identification information of the projector, and inputting the identification information of the projector in the conference system application, the user is capable of projecting an image using the projector. The user needs to perform such a series of work. The work is annoying for the user.

### SUMMARY

An image display method of a display device according to an aspect of the present disclosure includes: establishing first communication between the display device and a terminal device; transmitting, to the terminal device, via the first communication, an application for transmitting image information from the terminal device to the display device and connection information used for second communication for transmitting the image information; establishing the second communication when receiving a connection request for requesting to establish the second communication, the connection request being transmitted by the application operating in the terminal device; receiving the image information from the terminal device via the second communication; and displaying an image based on the image information.

### BRIEF DESCRIPTION OF THE DRAWINGS

FIG. 1 is a schematic diagram showing an image display system to which an image display method according to an embodiment is applied.

FIG. 2 is a block diagram showing the configuration of a projector.

FIG. 3 is a block diagram showing information stored in a storage device of the projector.

FIG. 4 is a block diagram showing functions of a CPU of the projector.

FIG. 5 is a block diagram showing the configuration of a terminal.

FIG. 6 is a block diagram showing information stored in a storage device of the terminal.

FIG. 7 is a block diagram showing functions of a CPU of the terminal.

FIG. 8 is a flowchart showing a procedure of an image display method according to a first embodiment.

FIG. 9 is a flowchart showing a procedure of an image display method according to a modification 3.

### DESCRIPTION OF EXEMPLARY EMBODIMENTS

Modes for carrying out the present disclosure are explained below with reference to the drawings. However, in the drawings, dimensions and scales of units are differentiated from actual ones as appropriate. Embodiments explained below are preferred specific examples of the present disclosure. Therefore, technically preferred various limitations are added to the embodiments. However, the scope of the present disclosure is not limited to these embodiments unless specifically noted in the following explanation that the present disclosure is limited.

### Image Display System 10

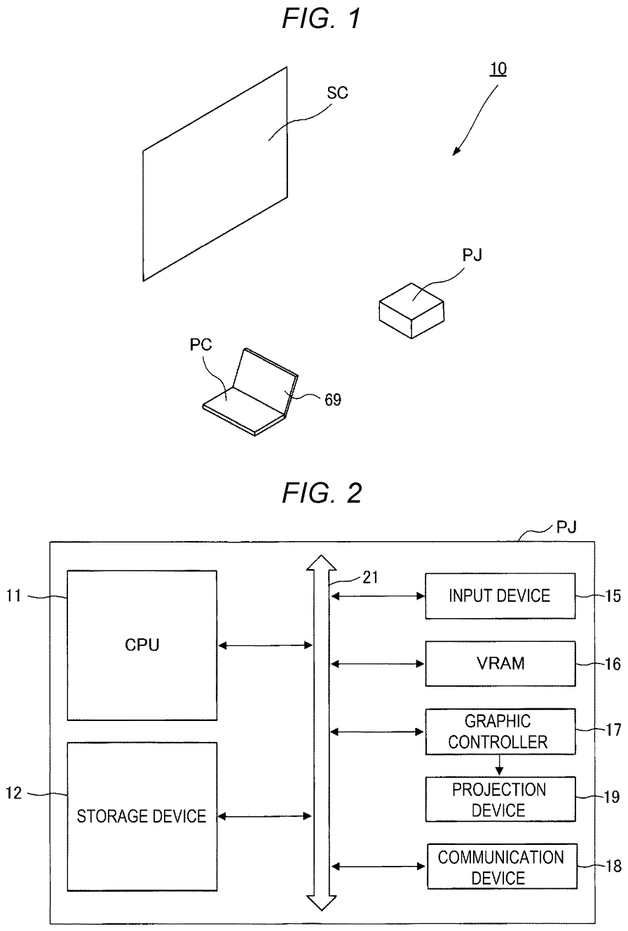

First, an image display system 10 to which an image display method of a display device according to an embodiment is applied is explained. After the image display system 10 is explained, the image display method of the display device is explained. FIG. 1 is a schematic diagram showing the image display system 10 to which the image display method according to the embodiment is applied. The image display system 10 shown in FIG. 1 can display a predetermined image using a network-type projector PJ. The projector PJ is connected to a terminal PC via a network. The projector PJ is an example of the display device. The terminal PC is an example of the terminal device. The projector PJ establishes connection to the terminal PC, receives image information from the terminal PC, and projects and displays an image on a screen SC.

Communication between the projector PJ and the terminal PC via the network includes “first communication” and “second communication”. The first communication is used to, for example, transmit a signal for requesting to establish the second communication and transmit a network projection application 34 and connection information 40 explained below. The second communication is used to transmit image information from the terminal PC to the projector PJ. The first communication and the second communication may be the same communication method or may be different communication methods.

### Communication Method

The projector PJ and the terminal PC are connected by a wireless LAN. The projector PJ and the terminal PC may communicate in an ad hoc mode not via an access point. A communication method between the projector PJ and the terminal PC is not limited to the forms explained above. Various methods can be applied as the communication method between the projector PJ and the terminal PC according to an environment of use, requested communication speed, and the like. For example, the projector PJ and the terminal PC may communicate in an infrastructure mode via the access point. The communication method between the projector PJ and the terminal PC is not limited to a wireless scheme. The projector PJ and the terminal PC may be configured to perform communication with, for example, a wired scheme using an Ethernet, a Firewire, a fiber channel, an SCSI, a Bluetooth, or a PLC. Ethernet, Firewire, and Bluetooth are registered trademarks. SCSI is an abbreviation of “Small Computer System Interface”. PLC is an abbreviation of “Power Line Communication”.

### Projector PJ

FIG. 2 is a block diagram showing the configuration of the projector PJ. The projector PJ shown in FIG. 2 includes a CPU 11, a storage device 12, an input device 15, a VRAM 16, a graphic controller 17, a communication device 18, and a projection device 19. The CPU 11, the storage device 12, the input device 15, the VRAM 16, the graphic controller 17, and the communication device 18 are connected by a bus 21. The projection device 19 is connected to the graphic controller 17. CPU is an abbreviation of “Central Processing Unit”. VRAM is an abbreviation of “Video Random Access Memory”.

The input device 15 includes buttons operable by a user. The input device 15 may include, for example, a display that can be touched and operated. The storage device 12 may include, for example, a ROM, a RAM, an EEPROM, and a HDD. The EEPROM is a rewritable nonvolatile memory. ROM is an abbreviation of “Read Only Memory”. RAM is an abbreviation of “Random Access Memory”. HDD is an abbreviation of “Hard Disk Drive”. EEPROM is an abbreviation of “Electrically Erasable Programmable ROM”. The CPU 11 may include one processor or may include a plurality of processors. The CPU 11 may be configured by an SoC (System on Chip) integrated with a part or the entire storage device 12 or another circuit. The CPU 11 may be configured by a combination with a DSP (Digital Signal Processor) that executes predetermined arithmetic processing.

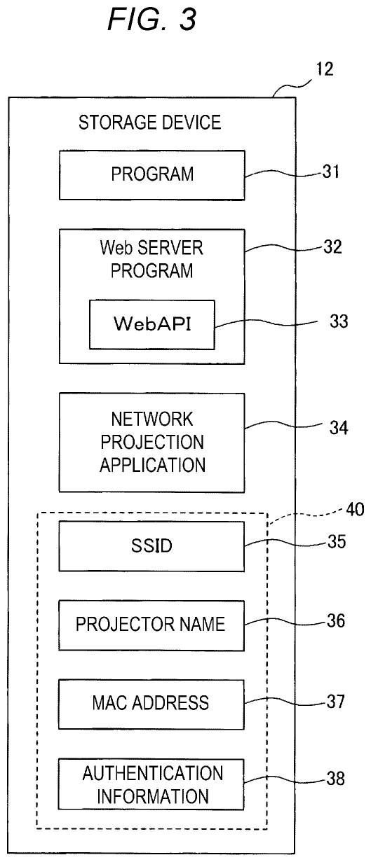

FIG. 3 is a block diagram showing information stored in the storage device 12 of the projector PJ. The storage device 12 stores various programs 31 for causing the projector PJ to operate. The storage device 12 stores a Web server program 32, a network projection application 34, an SSID 35, a projector name 36, a MAC address 37, and authentication information 38. The “network projection application” is hereinafter abbreviated as “projection application”. Web is an abbreviation of “World Wide Web”. SSID is an abbreviation of “Service Set Identifier”. MAC address is an abbreviation of “Media Access Control address”. The network projection application 34 is equivalent to the application.

The CPU 11 executes the Web server program 32, whereby a Web page displayed using a Web browser of the terminal PC is generated. The CPU 11 executes the Web server program 32, whereby a Web page for downloading the projection application 34 stored in the projector PJ is generated.

The Web server program 32 of the projector PJ includes a WebAPI 33. The WebAPI 33 sets network connection between the projector PJ and the terminal PC. The WebAPI 33 has a Web control function. The WebAPI 33 causes a display 69 of the terminal PC to display a Web page. The WebAPI 33 controls the operation of the terminal PC via the Web browser. “API” is an abbreviation of “Application Programming Interface”.

The WebAPI 33 is an interface that causes an application and a system of the terminal PC to operate via a network using an HTTP protocol. The WebAPI 33 can cause the projection application 34 to operate in the terminal PC. The WebAPI can open the Web browser in the terminal PC. “HTTP protocol” is an abbreviation of “Hypertext Transfer Protocol”.

The projection application 34 is an application installed in the terminal PC from the projector PJ and operates in the terminal PC. The projection application 34 can execute an operation for connecting the terminal PC and the projector PJ and an operation for transmitting image information from the terminal PC to the projector PJ.

The projection application 34 performs network setting in the ad hoc mode of the terminal PC and the projector PJ and establishes connection. The projection application 34 selects the projector PJ set as a connection destination and establishes connection to the projector PJ. The projection application 34 selects, as the connection destination, the projector PJ in which the projection application 34 is stored before being transmitted to the PC. The projection application 34 transmits the image from the terminal PC to the projector PJ and projects the image using the projector PJ.

For example, the SSID 35, the projector name 36, the MAC address 37, and the authentication information 38 are stored in the nonvolatile memory. The SSID 35, the projector name 36, the MAC address 37, and the authentication information 38 are examples of the connection information. The authentication information 38 stored in the storage device 12 of the projector PJ is transmitted to the terminal PC. The connection information 40 is used to establish communication used to transmit image information from the terminal PC to the projector PJ. The communication used to transmit the image information is an example of the second communication.

The SSID 35 is an SSID in a wireless network to which the projector PJ and the terminal PC are connected. The MAC address 37 is a MAC address of the projector PJ. The authentication information 38 is used for authentication for establishing communication used when image information is transmitted. The authentication information 38 includes, for example, a password or a passphrase.

The graphic controller 17 causes the projection device 19 to project an image using the VRAM 16 as a buffer. The projection device 19 includes a liquid crystal-type projection mechanism and projects lights transmitted through liquid crystal panels for colors of RGB to display an image on the screen SC. The projection device 19 is not limited to a projection device to which the liquid crystal type is applied. Various schemes such as DLP scheme, an LCOS scheme, and a GLV scheme can be used.

The communication device 18 includes, for example, a wireless interface. The wireless interface is an interface for performing wireless communication in the ad hoc mode and can perform peer-to-peer connection to the terminal PC. The communication device 18 may include a network interface. The network interface is an interface used when the projector PJ is connected to a local area network of a wired scheme.

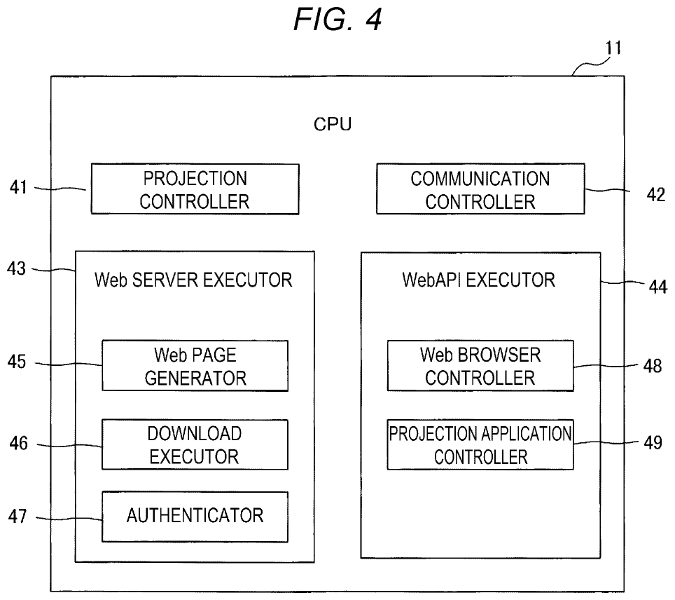

FIG. 4 is a block diagram showing functions of the CPU 11 of the projector PJ. The CPU 11 can control all the functions of the projector PJ by executing the programs 31 stored in the storage device 12. The CPU 11 executes the programs 31 to function as a projection controller 41 and a communication controller 42. The CPU 11 executes the Web server program 32 to function as a Web server executor 43 and a WebAPI executor 44. The Web server executor 43 includes a Web page generator 45, a download executor 46, and an authenticator 47. The WebAPI executor 44 includes a Web browser controller 48 and a projection application controller 49.

The projection controller 41 controls, for example, the graphic controller 17 and causes the screen SC to display an image using the projection device 19. The communication controller 42 controls communication between the projector PJ and the terminal PC using the communication device 18.

The Web page generator 45 generates a Web page displayed via the Web browser of the terminal PC. The download executor 46 causes the terminal PC to download the projection application 34 and the connection information 40 stored in the projector PJ. The authenticator 47 performs authentication for establishing communication for image information transmission. Communication between the projector PJ and the terminal PC is established by the authenticator 47 performing the authentication. The projector PJ can receive image information transmitted from the terminal PC by the operation of the projection application 34. The connection information 40 is equivalent to the connection information used for the second communication. The communication between the projector PJ and the terminal PC being established by the authenticator 47 performing the authentication is equivalent to the second communication.

After the communication between the terminal PC and the projector PJ is established, the Web browser controller 48 can open the Web page using the Web browser of the terminal PC. The projection application controller 49 can execute control for starting the projection application 34 in the terminal PC.

### Terminal PC

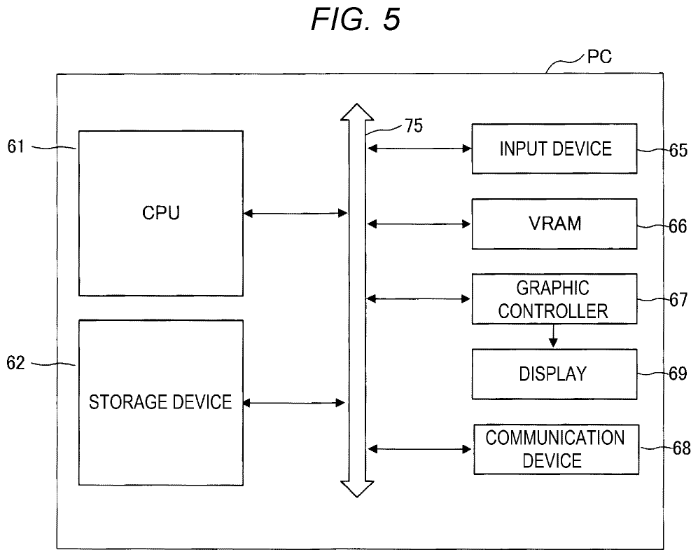

FIG. 5 is a block diagram showing the configuration of the terminal PC. The terminal PC includes a CPU 61, a storage device 62, an input device 65, a VRAM 66, a graphic controller 67, a communication device 68, and a display 69. The CPU 61, the storage device 62, the input device 65, the VRAM 66, the graphic controller 67, and the communication device 68 are connected by a bus 75. The display 69 is connected to the graphic controller 67.

The input device 65 includes a keyboard and a pointing device operable by the user. The pointing device is, for example, a mouse. The storage device 62 may include, for example, a ROM, a RAM, an EEPROM, and a HDD. The CPU 61 may include one processor or may include a plurality of processors. The CPU 61 may be configured by an SoC (System on Chip) integrated with a part or the entire storage device 62 or another circuit. The CPU 61 may be configured by a combination with a DSP that executes predetermined arithmetic processing.

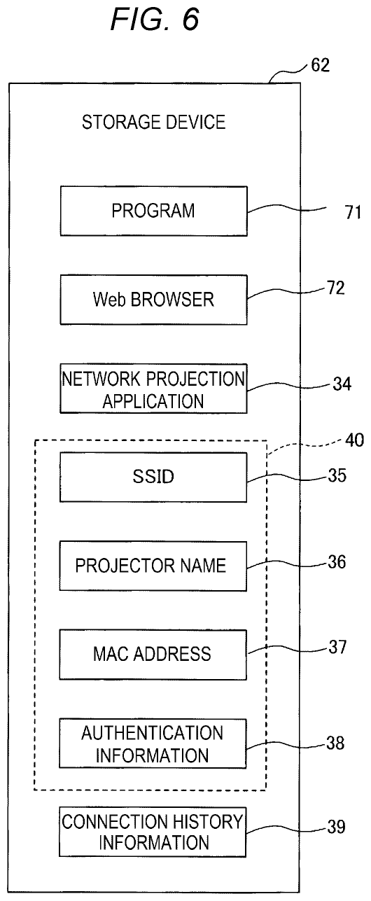

FIG. 6 is a block diagram showing information stored in the storage device 62 of the terminal PC. The storage device 62 stores various programs 71 for causing the projector PJ to operate. The storage device 62 stores a Web browser 72, the projection application 34, the SSID 35, the projector name 36, the MAC address 37, the authentication information 38, and connection history information 39. The projection application 34, the SSID 35, the projector name 36, the MAC address 37, and the authentication information 38 are downloaded from the projector PJ and stored in the storage device 62.

The connection history information 39 includes information concerning a connection history to the projector PJ connected using the projection application 34. For example, the connection history information 39 includes identification information for identifying an individual projector PJ. The connection history information 39 may include information for correlating the projector PJ connected in the past and the connection information 40 for connection to the projector PJ.

The projection application 34, the SSID 35, the projector name 36, the MAC address 37, and the authentication information 38 stored in the storage device 62 are the connection information 40 downloaded from the projector PJ as explained above.

The graphic controller 67 causes the display 69 to display an image using the VRAM 66 as a buffer.

The communication device 68 includes, for example, a wireless interface. The wireless interface is an interface for performing wireless communication in the ad hoc mode and can perform peer-to-peer connection to the terminal PC. The communication device 68 may include a network interface. The network interface is an interface used when the projector PJ is connected to a local area network of a wired scheme.

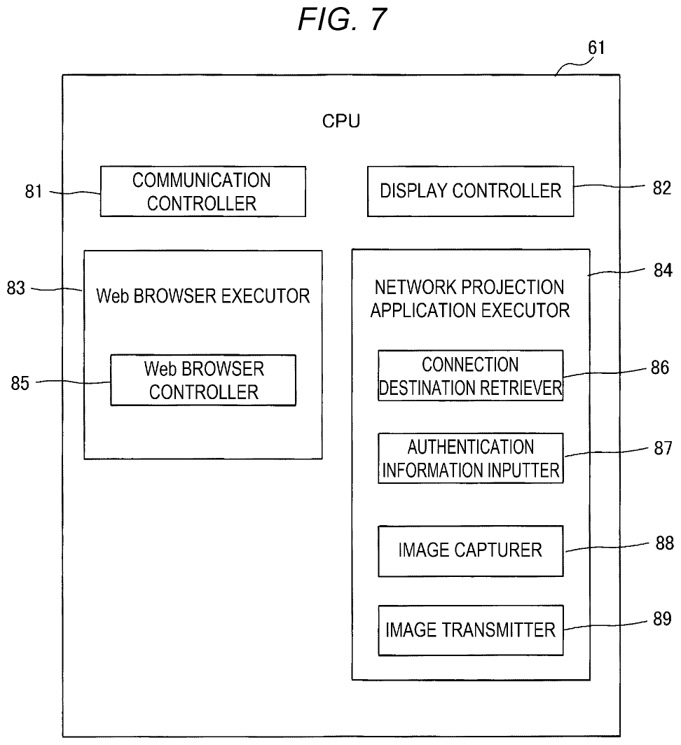

FIG. 7 is a block diagram showing functions of the CPU 61 of the terminal PC. The CPU 61 can control all the functions of the terminal PC by executing the programs 71 stored in the storage device 62. The CPU 61 executes the programs 71 to function as a communication controller 81 and a display controller 82. The CPU 61 executes the Web browser 72 to function as a Web browser controller 85. The Web browser executor 83 includes the Web browser controller 85. The Web browser controller 85 executes control using the Web browser. The CPU 61 executes the projection application 34 to function as a network projection application executor 84. The network projection application executor is hereinafter described as projection application executor.

The communication controller 81 controls communication between the terminal PC and the projector PJ using the communication device 68 of the terminal PC. The display controller 82 executes display control in the display 69 of the terminal PC.

The projection application executor 84 functions as a connection destination retriever 86, an authentication information inputter 87, an image capturer 88, and an image transmitter 89. The connection destination retriever 86 retrieves the projector PJ set as the connection destination from the connection information 40 downloaded from the projector PJ. Specifically, the connection destination retriever 86 specifies the projector PJ set as the connection destination referring to the SSID 35, the projector name 36, and the MAC address 37 included in the connection information 40.

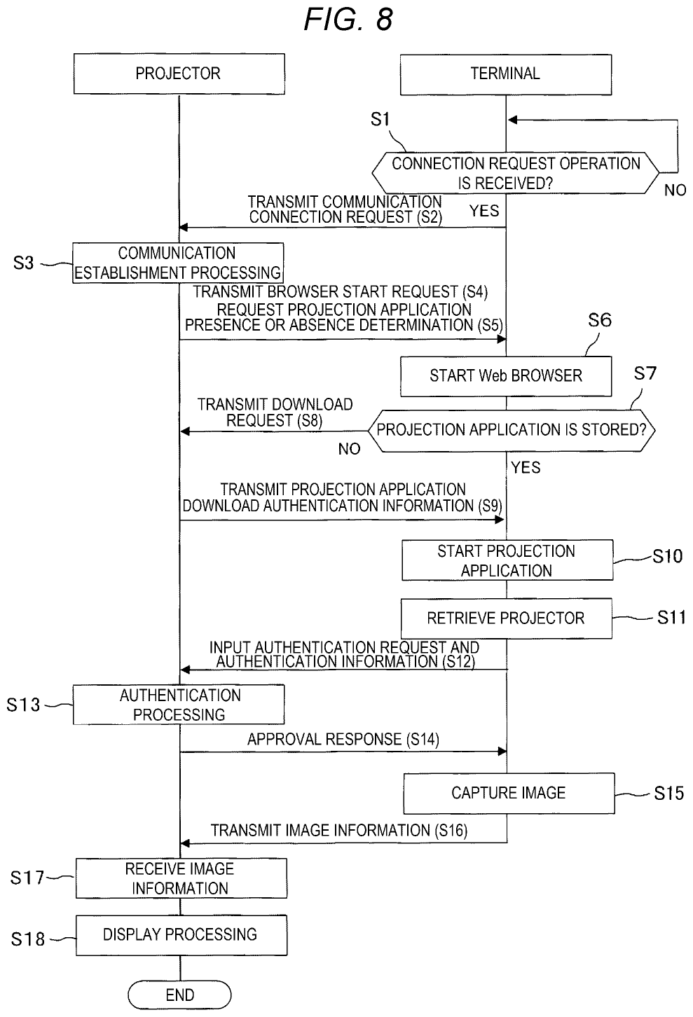

The authentication information inputter 87 transmits, to the projector PJ, the authentication information 38 downloaded from the projector PJ set as the connection destination. The image capturer 88 controls an operation for capturing image information displayed on the display 69 of the terminal PC. The image transmitter 89 controls an operation for transmitting the captured image information to the projector PJ. A procedure of these operations by the projection application executor 84 is explained below with reference to a flowchart of FIG. 8.

### Image Display Method of the Display Device

An image display method of the display device is explained below. The image display method of the display device according to this embodiment can be executed using the projector PJ explained above. However, the image display method of the display device is not limited to the image display method executed using the projector PJ.

### First Embodiment

An image display method according to a first embodiment is explained with reference to the flowchart of FIG. 8. FIG. 8 is a flowchart showing a procedure of the image display method according to the first embodiment.

When causing the screen SC to display, using the projector PJ, an image displayed on the display 69 of the terminal PC, the user operates the terminal PC and connects the terminal PC and the projector PJ through a network. First, the CPU 61 of the terminal PC determines whether a request operation for connection to the network is received (step S1). When the request operation for connection is received (YES in step S1), the CPU 61 functions as the communication controller 81 and transmits a communication connection request to the projector PJ (step S2). When the request operation for communication is not received (NO in step S1), the CPU 61 repeats the processing in step S1.

The projector PJ receives the communication connection request transmitted from the terminal PC. The CPU 11 of the projector PJ functions as the communication controller 42, receives the communication connection request, and, thereafter, executes communication establishment processing (step S3).

Subsequently, the CPU 11 functions as the Web browser controller 48 and transmits a browser start request to the terminal PC (step S4). The browser start request is equivalent to the start request for instructing to start the Web browser. The CPU 11 can function as the Web browser controller 48 and transmit a URL to the terminal PC. The CPU 11 transmits, to the terminal PC, an application presence or absence determination request for instructing the terminal PC to determine whether the projection application 34 is stored in the terminal PC (step S5). In step S5, the CPU 11 functions as the WebAPI executor 44.

The CPU 61 of the terminal PC starts the Web browser 72 while being triggered by the CPU 61 receiving the browser start request (step S6). In step S6, the CPU 11 functions as the Web browser controller 85. Subsequently, the CPU 61 determines whether the projection application 34 is stored in the storage device 62 (step S7). When the projection application 34 is stored in the storage device 62 (YES in step S7), the CPU 61 proceeds to step S10.

When the projection application 34 is not stored in the storage device 62 (NO in step S7), the CPU 61 transmits, to the projector PJ, a download request for requesting the projector PJ to download the projection application 34 (step S8).

The projector PJ receives the download request transmitted from the terminal PC. Subsequently, the CPU 11 transmits, to the terminal PC, the projection application 34 and the authentication information 38 stored in the storage device 12 (step S9). The CPU 11 transmits the SSID 35, the projector name 36, and the MAC address 37 stored in the storage device 12 to the terminal PC. In step S9, the CPU 11 functions as the download executor 46.

Instead of transmitting the projector name 36 to the terminal PC, the CPU 11 may change a file name of the authentication information 38 to a file name including the projector name 36 and transmit the authentication information 38 to the terminal PC using the changed file name. For example, when the file name of the authentication information 38 before the change is “crf.info” and the projector name is “EP123”, the CPU 11 may function as the download executor 46, change the file name of the authentication information 38 to “EP123_crf.info”, and transmit the authentication information 38.

The terminal PC receives the projection application 34, the authentication information 38, the SSID 35, the projector name 36, and the MAC address 37 transmitted from the projector PJ. The storage device 62 of the terminal PC stores the projection application 34, the SSID 35, the projector name 36, the MAC address 37, and the authentication information 38 received by the terminal PC.

Subsequently, the CPU 61 of the terminal PC starts the projection application 34 (step S10). For example, the CPU 61 may start the projection application 34 in response to manual operation by the user. For example, the projection application controller 49 may start the projection application 34. The CPU 61 may start the projection application 34 after step S7 or step S8 and before step S9 is executed. Subsequently, the terminal PC functions as the connection destination retriever 86 and retrieves and specifies, based on the SSID 35, the projector name 36, and the MAC address 37 stored in the storage device 62, the projector PJ set as the connection destination (step S11).

Subsequently, the CPU 61 inputs, to the projector PJ, an authentication request and authentication information for establishing communication for image transmission (step S12). The CPU 61 transmits the authentication request and the authentication information to the projector PJ. In step S12, the CPU 61 functions as the authentication information inputter 87.

The projector PJ receives the authentication request and the authentication information transmitted from the terminal PC. The CPU 11 functions as the authenticator 47 and, while being triggered by the CPU 11 receiving the authentication request, executes authentication processing for collating the authentication information (step S13). When the authentication information is correct, the CPU 11 establishes communication for image transmission from the terminal PC to the projector PJ. Consequently, the second communication is established. The projector PJ transmits, to the terminal PC, an approval response indicating that the second communication is approved to be established (step S14).

The CPU 61 of the terminal PC receives the approval response transmitted from the projector PJ. Subsequently, the CPU 61 functions as the image capturer 88 and, while being triggered by an operation input of the user, captures image information displayed on the display 69 of the terminal PC (step S15). The CPU 61 functions as the image transmitter 89 and transmits the captured image information to the projector PJ using the second communication (step S16).

The CPU 11 of the projector PJ receives the image information transmitted from the terminal PC (step S17). The CPU 11 functions as the projection controller 41 and projects an image indicated by the received image information onto the screen SC (step S18).

With such an image display method, the projection application 34 and the connection information 40 stored in the storage device 12 of the projector PJ are transmitted to the terminal PC. Therefore, the terminal PC can easily retrieve, from the received connection information 40, the projector PJ set as the connection destination. Consequently, the user does not need to manually retrieve the projector PJ set as the connection destination. As a result, time of the user for connecting the terminal PC to the projector PJ can be saved.

With the image display method, the authentication information 38 can be transmitted to the projector PJ using the projection application 34 transmitted from the projector PJ to the terminal PC. The projector PJ can perform the authentication processing using the authentication information 38 transmitted by the operation of the projection application 34 and establish the second communication. Consequently, time of the user for inputting the authentication information can be saved. Since the authentication information is automatically input by the projection application 34, a mistake in inputting the authentication information 38 by the user can be prevented.

With the image display method, since the Web browser can be started in the terminal PC after the first communication is established, the projection application 34 to the terminal PC can be easily downloaded. With the image display method, the terminal PC and the projector PJ can be easily connected using the Web function of the projector PJ.

In the image display method, since the projector PJ and the terminal PC can be communicably connected using the wireless network, for example, the projector PJ suspended from the ceiling and the terminal PC can be easily connected.

The image display method of the display device includes establishing the first communication between the projector PJ and the terminal PC, transmitting, to the terminal PC, via the first communication, the projection application 34 for transmitting image information from the terminal PC to the projector PJ and connection information used for the second communication for transmitting the image information, establishing the second communication when receiving a connection request for requesting to establish the second communication, the connection request being transmitted by the projection application 34 operating in the terminal PC, receiving the image information from the terminal PC via the second communication, and displaying an image based on the image information.

In the image display method, the first communication can be established between the projector PJ and the terminal PC. In the image display method, the projection application 34 and the connection information can be transmitted from the projector PJ to the terminal PC via the first communication. With the image display method, the projection application 34 operates in the terminal PC, whereby the connection request for requesting to establish the second communication can be transmitted to the projector PJ. With the image display method, the projector PJ can establish the second communication when receiving the connection request for requesting to establish the second communication. With the image display method, the projector PJ can receive the image information from the terminal PC via the second communication. With the image display method, the projector PJ can display the image based on the image information. As a result, in the image display method, the user's time can be saved.

The image display method further includes, after the establishing the first communication, transmitting, to the terminal PC, via the first communication, a start request for instructing the terminal PC to start a Web browser. With the image display method, the Web browser can be started in the terminal PC after the first communication is established. Consequently, in the image display method, the user's time can be saved. The user does not need to start the Web browser.

The image display method further includes transmitting, to the terminal PC, via the first communication, a request for instructing the terminal PC to determine whether the projection application 34 is stored in the terminal PC. Consequently, in the image display method, the terminal PC can determine whether the projection application 34 is stored in the terminal PC. Accordingly, the user does not need to check whether the projection application 34 is stored. As a result, the user's time can be saved. When the projection application 34 is stored, the projection application 34 can be prevented from being downloaded. Accordingly, the user does not need to determine whether to download the projection application 34.

In the image display method, the connection information includes authentication information for authenticating the connection request. In the image display method, the connection information including the authentication information can be transmitted to the terminal PC. Therefore, the user does not need to input the authentication information to the terminal PC. As a result, the user's time can be saved.

In the image display method, the projector PJ stores the projection application 34 and the connection information. In the image display method, the projection application 34 and the connection information stored in advance in the projector PJ can be transmitted to the terminal PC. In the image display method, the user can request the projector PJ, in which the projection application 34 and the connection information are stored, to establish the second communication. In the image display method, when requesting to establish the second communication, the user does not need to select the projector PJ. As a result, the user's time can be saved.

### MODIFICATION 1

The image display method may be changed and executed as appropriate. In the embodiment explained above, the terminal PC determines whether the projection application 34 is stored in the storage device 62 of the terminal PC. However, without carrying out this determination processing, the terminal PC may request the projector PJ to download the projection application 34.

### MODIFICATION 2

In the embodiment explained above, the projection application 34 and the authentication information 38 are transmitted from the projector PJ to the terminal PC. However, the projection application 34 and the authentication information 38 may not be transmitted after the first communication is established. For example, when the projector PJ and the terminal PC were connected in the past and the projection application 34 and the authentication information 38 are stored in the storage device 62 of the terminal PC, the authentication information 38 stored in the storage device 62 can be used. When the projector PJ has already transmitted the authentication information 38 to the terminal PC, the projector PJ does not need to transmit the authentication information 38 to the terminal PC again. Similarly, when the projector PJ has already transmitted the connection information 40 such as the SSID 35, the projector name 36, and the MAC address 37 to the terminal PC, the projector PJ does not need to transmit the connection information 40 to the terminal PC again. The terminal PC can use the connection information 40 stored in the storage device 62. The terminal PC can grasp a connection history of the terminal PC and the projector PJ set as the connection destination referring to the connection history information 39.

The terminal PC can save the connection history information 39 after the second communication is established. The connection history information 39 includes information for identifying the projector PJ, which is the connection destination, and the connection information 40 of the projector PJ at the connection destination.

### MODIFICATION 3

The projector PJ can transmit the projection application 34 including the connection information 40 to the terminal PC. The CPU 11 can function as the download executor 46, read the projection application 34 and the connection information 40 stored in the storage device 12, and set the connection information 40 as a file name of the projection application 34. The CPU 11 can function as the download executor 46 and include, for example, the projector name 36, which is the connection information 40, in the file name of the projection application 34. The CPU 11 can function as the download executor 46 and transmit the projection application 34, in the file name of which the connection information 40 is included, to the terminal PC. The including the projector name 36, which is the connection information 40, in the file name of the projection application 34 is equivalent to the adding the connection information to the name of the application.

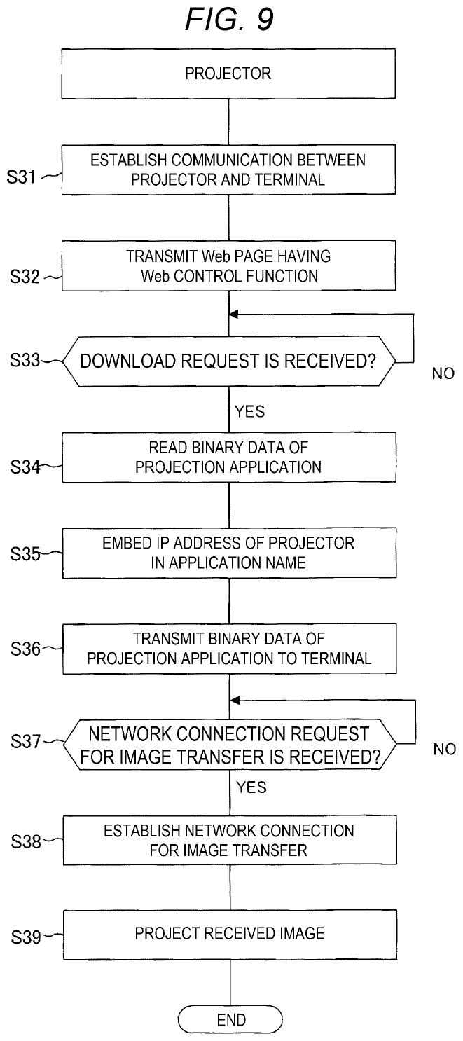

FIG. 9 is a flowchart showing a procedure of an image display method according to the modification 3. In FIG. 9, a procedure executed in the projector PJ is shown. The projector PJ waits for a connection request from the terminal PC and establishes communication between the projector PJ and the terminal PC (step S31). The CPU 11 transmits a Web page having a Web control function to the terminal PC (step S32).

A Web page including a link to the projection application 34 stored in the storage device 12 of the projector PJ is displayed on the display 69 of the terminal PC. By clicking the link to the projection application 34, the user can request the projector PJ to download the projection application 34. The projector PJ can receive the download request transmitted from the terminal PC.

The CPU 11 of the projector PJ determines whether the download request for the projection application 34 is received from the terminal PC (step S33). When the download request is received (YES in step S33), the CPU 11 proceeds to step S34. When the download request is not received (NO in step S33), the CPU 11 waits for the download request and proceeds to step S34.

In step S34, the CPU 11 functions as the download executor 46 and reads binary data of the projection application 34 stored in the storage device 12. Subsequently, the CPU 11 functions as the download executor 46 and embeds an IP address of the projector PJ in a name of a file of the projection application 34 (step S35). Subsequently, the CPU 11 transmits, to the terminal PC, the binary data of the projection application 34 to which the IP address is added (step S36). In step S36, the CPU 11 functions as the download executor 46.

The terminal PC can read the file name of the received projection application 34 and acquire the IP address of the projector PJ set as the connection destination. Consequently, the terminal PC can specify the projector PJ set as the connection destination. The connection information 40 included in the projection application 34 is not limited to the IP address and the projector name. For example, the projection application 34 may include other connection information 40 such as a network name.

The CPU 61 of the terminal PC can store the received projection application 34 in the storage device 62 based on operation by the user. The CPU 61 of the terminal PC can start the projection application 34 based on operation by the user. The CPU 61 functions as the connection destination retriever 86, reads the file name of the projection application 34, and specifies the IP address of the projector PJ set as the connection destination and the network name of the projector PJ. The CPU 61 functions as the projection application executor 84 and transmits a network connection request for image transfer to the projector PJ set as the connection destination. The network connection for image transfer is an example of the second communication.

The CPU 11 of the projector PJ determines whether the network connection request for image transfer is received (step S37). When the network connection request is received (YES in step S37), the CPU 11 proceeds to step S38. When the network connection request is not received (NO in step S37), the CPU 11 waits for reception of the network connection request and proceeds to step S38.

In step S38, the CPU 11 functions as the communication controller 42 and establishes network connection for image transfer. As explained above, the CPU 61 of the terminal PC functions as the image capturer 88 and captures an image displayed on the display 69 of the terminal PC. The CPU 11 functions as the image transmitter 89 and transmits image information based on the captured image to the projector PJ. The projection device 19 of the projector PJ projects the received image (step S39).

In such an image display method according to the modification 3, the IP address of the projector PJ can be embedded in the application name of the projection application 34 and transmitted to the terminal PC. Therefore, the projection application 34 operating on the terminal PC can easily specify the projector PJ set as the connection destination from the application name.

In the image display method, for example, when the terminal PC of the user is connected to the projector PJ set in a conference room where the user is visiting, the user starts the Web browser in the terminal PC and selects the projector PJ displayed on the Web browser, whereby the first communication is established and the projection application 34 is downloaded to the terminal PC. The projection application 34 operating on the terminal PC can select the projector PJ set as the connection destination from the application name of the downloaded projection application 34 and request the projector PJ to establish the second communication for image transfer. As a result, a work load of the user in transferring an image is reduced.

In the image display method, since the projector PJ and the terminal PC can be wirelessly connected, when terminals PC of a plurality of users in a conference room are switched and the projector PJ is used, it is unnecessary to connect a connection cable again unlike the related art.

The image display method further includes adding the connection information to a name of the projection application 34 before transmitting the projection application 34 to the terminal PC. In the image display method, the connection information can be added to the name of the projection application 34. The projection application 34, to the name of which the connection information is added, can be transmitted to the terminal PC. The terminal PC can read the name of the projection application 34 and acquire the connection information. Consequently, the user's time can be saved.

### MODIFICATION 4

In the embodiment explained above, the projector PJ transmits the projection application 34 and the authentication information to the terminal PC. However, the projector PJ may transmit the authentication information to the terminal PC without transmitting the projection application 34. When the projection application 34 is stored in the storage device 62 of the terminal PC, the projector PJ can transmit the connection information 40 including the authentication information of the projector PJ set as the connection destination to the terminal PC without transmitting the projection application 34. In the image display method, when the terminal PC is connected to another projector in the past, the projection application 34 is sometimes stored in the storage device 62. In such a case, the projector PJ can transmit the connection information 40 to the terminal PC without transmitting the projection application 34. Consequently, an increase in a communication amount can be suppressed.

The image display method further includes transmitting the connection information to the terminal PC without transmitting the projection application 34 when the projection application 34 is stored in the terminal PC. With such an image display method, an increase in a communication amount can be suppressed.

The embodiment explained above only indicates a representative mode of the present disclosure. The present disclosure is not limited to the embodiment explained above. Various changes and additions are possible without departing from the gist of the present disclosure.

In the embodiment explained above, the projector PJ is illustrated as the display device. However, the display device is not limited to the projector PJ. The display device may be another display device such as a liquid crystal display device. In the embodiment explained above, the terminal PC is illustrated as the terminal device. However, the terminal device may be another terminal device such as a smartphone or a tablet computer.

What is claimed is:

1. An image display method of a display device comprising:
establishing first communication between a display device and a terminal device;
transmitting, to the terminal device, via the first communication, an application for transmitting image information from the terminal device to the display device and connection information used for second communication for transmitting the image information;
establishing the second communication when receiving a connection request for requesting to establish the second communication, the connection request being transmitted by the application operating in the terminal device;
receiving the image information from the terminal device via the second communication; and
displaying an image based on the image information.

2. The image display method of the display device according to claim 1, further comprising, after establishing the first communication, transmitting, to the terminal device, via the first communication, a start request for instructing the terminal device to start a Web browser.

3. The image display method of the display device according to claim 1, further comprising adding the connection information to a name of the application before transmitting the application to the terminal device.

4. The image display method of the display device according to claim 1, further comprising transmitting, to the terminal device, via the first communication, a request for instructing the terminal device to determine whether the application is stored in the terminal device.

5. The image display method of the display device according to claim 1, further comprising transmitting the connection information to the terminal device without transmitting the application when the application is stored in the terminal device.

6. The image display method of the display device according to claim 1, wherein the connection information includes authentication information for authenticating the connection request.

7. The image display method of the display device according to claim 1, wherein the display device stores the application and the connection information.
